(19) United States
(12) Patent Application Publication
(10) Pub. No.: US 2005/0163085 A1
(43) Pub. Date: Jul. 28, 2005

(54) System and method for autonomic wireless presence ping

(75) Inventors: Daryl Carvis Cromer, Apex, NC (US); Philip John Jakes, Durham, NC (US); Howard Jeffrey Locker, Cary, NC (US); Randall Scott Springfield, Chapel Hill, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/747,705

(22) Filed: Dec. 24, 2003

(51) Int. Cl. H04Q 7/24

(52) U.S. Cl. 370/338

(57) ABSTRACT

A system and method for autonomic wireless presence ping is presented. An IS administrator wishes to collect capacity requirement information corresponding to a wireless network, such as the number of packets a client sends to and receives from an access point. The IS administrator sends a request to the access point. In turn, the access point sends a control packet to client devices it supports, instructing them to enable an enhanced presence ping bit. Each client enables its enhanced presence ping bit, and collect enhanced status information. Each client device sends the enhanced status information to the access point either when a timer expires, or when the client device receives a ping request from the access point. The access point then forwards the enhanced status information to the IS administrator for analysis.

### BACKGROUND OF THE INVENTION

1. Technical Field

The present invention relates in general to a system and method for autonomic wireless presence ping. More particularly, the present invention relates to a system and method for client devices to provide enhanced status information to an administrator that, in turn, allows the administrator to identify spatial capacity requirements within a network.

2. Description of the Related Art

Wireless LANs are increasing in popularity and becoming accepted for use in enterprise networks. As expected, users require the same level of consistency and quality of service from wireless LANs as they do with traditional wired LANs. A wireless LAN, however, is fundamentally different than a wired LAN, and being able to provide the same quality of service in a wireless LAN requires overcoming some key technical challenges.

In the case of 802.11b wireless LAN technology, a shared transmission medium exists between an access point and client devices that defines fourteen separate channels in which to communicate. However, only three of the fourteen channels are non-overlapping in frequency spectrum. Therefore, since there are only three non-overlapping channels, a challenge found is that an information system administrator may only use the three non-overlapping channels in an adjacent, honeycomb pattern for a network layout. This limitation prohibits the amount of traffic that an 802.11b network may support. For example, a single 802.11b channel's throughput is about 5.5 Mbps. Since an 802.11b layout is limited to three channels, an 802.11b network's maximum capacity is about 16.5 Mbps.

Information system administrators may prefer to deploy 802.11b networks given that they are the lowest cost and most stable compared to the other 802.11 standards, such as 802.11a and 802.11g. 802.11a and 802.11g networks may, however, be overlaid in hot spots to address capacity issues. A challenge found is for an information system administrator to identify actual spatial capacity requirements within a given wireless network. A wired network uses a dedicated medium between a hub and a client that allows a hub to continually receive actual demand from a client. In a wireless network, however, due to its shared transmission medium, an access point only receives a single demand from a single client at any given time.

What is needed, therefore, is a system and method to identify actual spatial capacity requirements for client devices that communicate over a wireless LAN environment.

### SUMMARY

It has been discovered that the aforementioned challenges are resolved by using an enhanced presence ping to instruct client devices to provide enhanced status information to an access point that allows an information system administrator to identify a network's actual spatial capacity requirements. An information system administrator wishes to collect enhanced status information corresponding to client devices that an access point supports. For example, enhanced status information may be a client's total packets sent to and received from the access point.

The information system administrator sends an administrator request to the access point over a computer network, such as the Internet. The access point receives the request, and determines that is should notify client devices to enable enhanced presence ping. The access point generates an enhanced presence ping control packet, and sends the enhanced presence ping control packet to each client device over a wireless network, such as 802.11b. The enhanced presence ping control packet instructs each client device to enable an enhanced presence ping bit, and also instructs each client device as to which type of enhanced status information to collect and send to the access point.

Each client device receives the enhanced presence ping control packet, and enables an enhanced presence ping bit. In addition, each client device identifies, based upon the enhanced presence ping control packet, whether it should push enhanced status information to the access point or whether it should wait for a ping request from the access point before providing the enhanced status information.

If a client device identifies that it should push enhanced status information to the access point, the client device enables a timer. The timer is set at particular intervals, such as hourly, and instructs the client device when to send enhanced status information to the access point. When the timer expires, the client device collects the enhanced status information, includes it in a response, and sends the response to the access point. The access point receives the enhanced status information, and passes the enhanced status information to the IS administrator through a computer network.

If, on the other hand, the client device identifies that it should not push the enhanced status information to the access point, the client device waits for a ping request from the access point. When the client device receives the ping request, the client device collects the enhanced status information, includes it in a response, and sends the response to the access point.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a client providing enhanced status information in response to an enhanced presence ping request;

FIG. 2 is a data packet diagram showing various data that is sent from a client to an access point;

FIG. 3 is a flowchart showing steps taken in an access point receiving an enhanced presence ping request, and sending control packets to clients that instruct the clients to provide enhanced status information to the access point;

FIG. 4 is a high level flow chart showing steps taken in a client receiving a control packet from an access point, and enabling its enhanced presence ping bit in response to the control packet;

FIG. 5 is a flowchart showing steps taken in a client collecting enhanced presence information and sending the enhanced presence information to an access point;

FIG. 6 is a block diagram of an access point that is capable of adapting to the present invention; and

FIG. 7 is a block diagram of an information handling system, such as a client device, capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

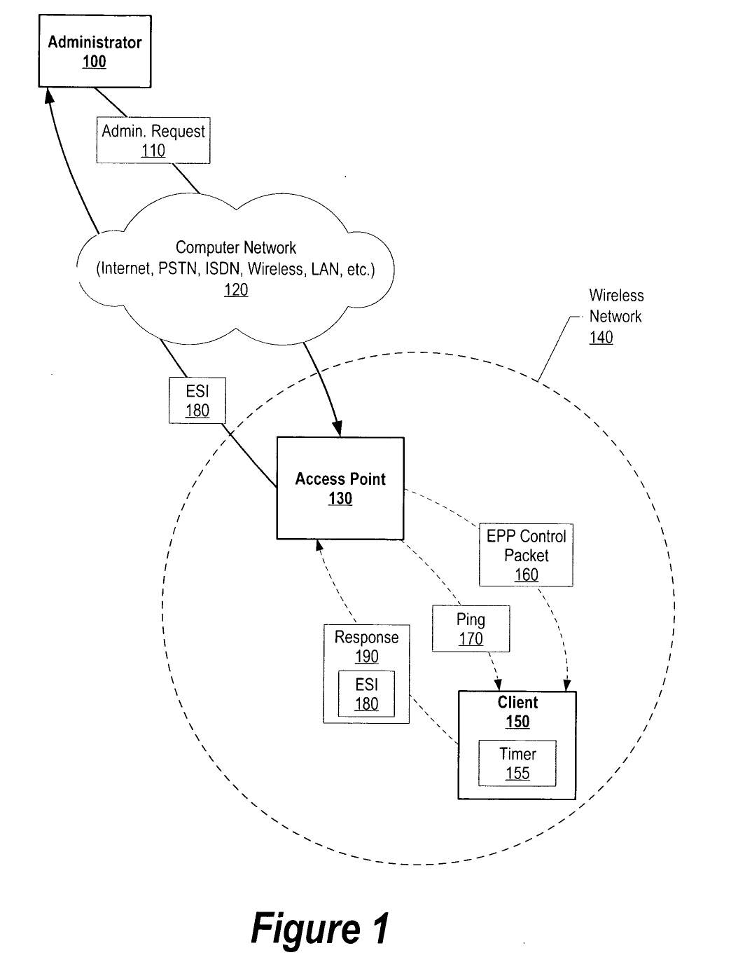

FIG. 1 is a diagram showing a client providing enhanced status information to an access point. Administrator 100 wishes to collect enhanced status information corresponding to clients that access point 130 supports. For example, enhanced status information may be a client's total packets sent to and received from access point 130. Administrator 100 sends administrator request 110 to access point 130 over computer network 120, such as the Internet. Access point 130 receives the request, and determines that is should notify clients to enable enhanced presence ping.

Access point 130 communicates with client 150 over wireless network 140, such as an 802.11 network. Access point 130 generates enhanced presence ping control packet 160, and sends enhanced presence ping control packet 160 to client 150 over wireless network 140. Enhanced presence ping control packet 160 instructs client 150 to enable enhanced presence ping mode, and also instructs client 150 as to what type of enhanced status information to collect.

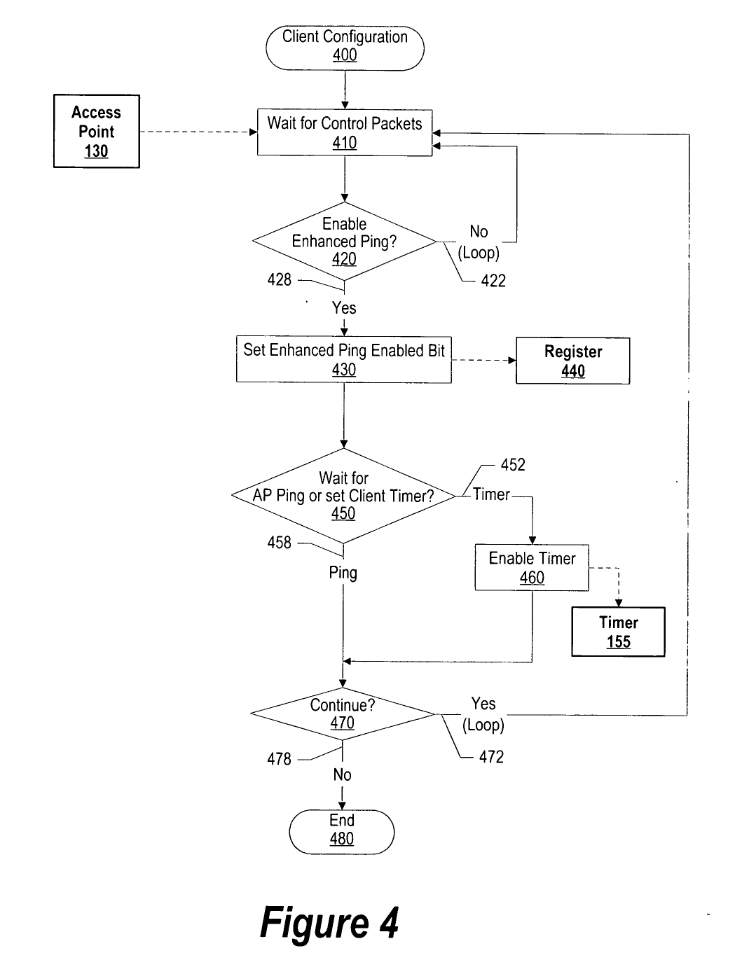

Client 150 receives enhanced presence ping control packet 160, and enables an enhanced presence ping bit (see FIG. 4 and corresponding text for further details regarding enhanced presence ping bit setting). Client 150 also determines, based upon enhanced presence ping control packet 160, whether it should push enhanced status information to access point 130, or whether it should wait for a ping request from access point 130 before providing the enhanced status information. If client 150 determines that it should push enhanced status information to access point 130, client 150 enables timer 155. Timer 155 is set at particular intervals, such as thirty minutes, and instructs client 150 when to send enhanced status information to access point 130.

When timer 155 expires, client 150 collects enhanced status information 180, includes it in response 190, and sends response 190 to access point 130. Access point 130 receives enhanced status information 180, and passes enhanced status information 180 to administrator 100 through computer network 120. If, on the other hand, client 150 was not requested to push enhanced status information to access point 130, client 150 waits for ping request 170 from access point 130. When client 150 receives ping request 170, client 150 collects enhanced status information 180, includes it in response 190, and sends response 190 to access point 130.

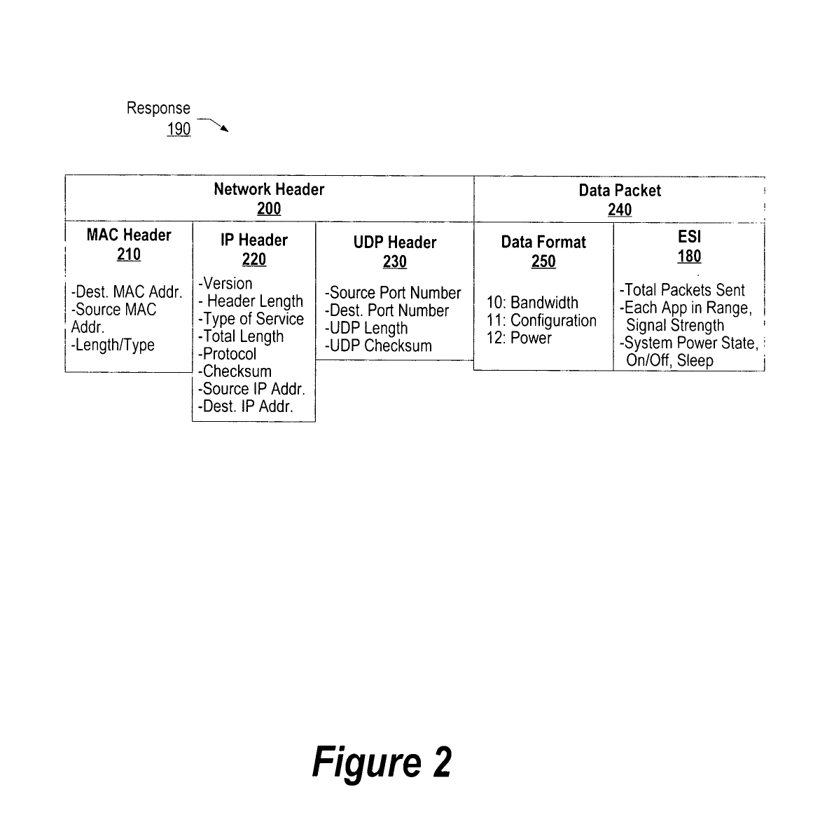

FIG. 2 is a diagram of a response packet that is sent from a client to an access point. Response 190 is the same as that shown in FIG. 1 and includes network header 200 and data packet 240. Network header 200 includes MAC header 210, IP header 220, and UDP header 230, each of which includes various network information corresponding to a client/access point connection.

Data packet 240 includes data format 250 and enhanced status information 180. Data format 250 includes up to three types of data which may be data corresponding to bandwidth, configuration, and power. Enhanced status information 180 is the same as that shown in FIG. 1 and includes the enhanced status information corresponding to the data type selections located in data format 250. For example, if a client is requested to send bandwidth information, the client may include total packets sent in enhanced status information 180. In another example, if the client is requested to provide configuration information, the client may include a signal strength reading. In yet another example, if the client is requested to provide power information, the client may include a system power state in enhanced status information 180 to send to an access point.

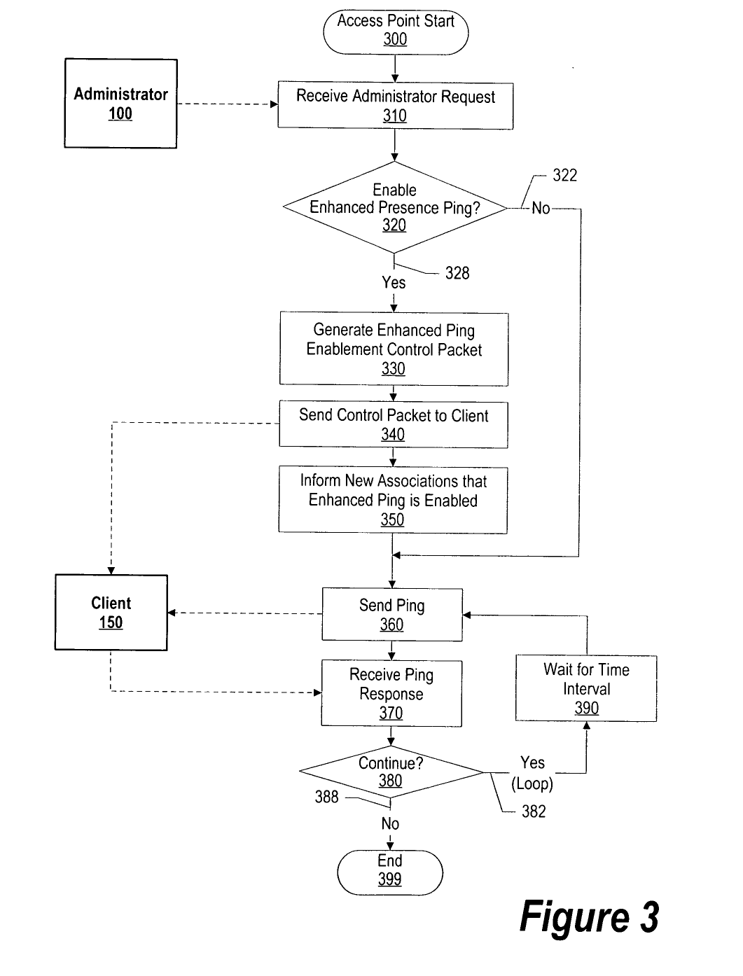

FIG. 3 is a flowchart showing steps taken in an access point receiving an enhanced presence ping request, and sending control packets to clients that instruct the clients to provide enhanced status information to the access point. Access point processing commences at 300, whereupon processing receives an administrator request from administrator 100 (step 310). Administrator 100 is the same as that shown in FIG. 1.

A determination is made as to whether administrator 100 wishes to enable enhanced presence ping based upon the administrator request (decision 320). Enhanced presence ping instructs an access point to inform clients to provide enhanced status information, such as the total number of packets that a client transmits and receives (see FIG. 2 and corresponding text for further details regarding status information). If administrator 100 does not wish to enable enhanced presence ping, decision 320 branches to “No” branch 322 bypassing enhanced presence ping enablement steps.

On the other hand, if administrator 100 wishes to enable enhanced presence ping, decision 320 branches to “Yes” branch 328 whereupon the access point generates an enhanced presence ping control packet (step 330). The enhanced presence ping control packet instructs a client to enable enhanced presence ping and which type of enhanced status information to collect. Processing sends the control packet to client 150 at step 340. Client 150 is the same as that shown in FIG. 1. In one embodiment, the access point sends the control packet to each client that is active on the access point's network. Processing informs new associations that enhanced presence ping is enabled at step 350. For example, when a new client joins the access point's network, the access point promptly informs the new client to enable enhanced presence ping instead of the client having to wait for a broadcast announcement.

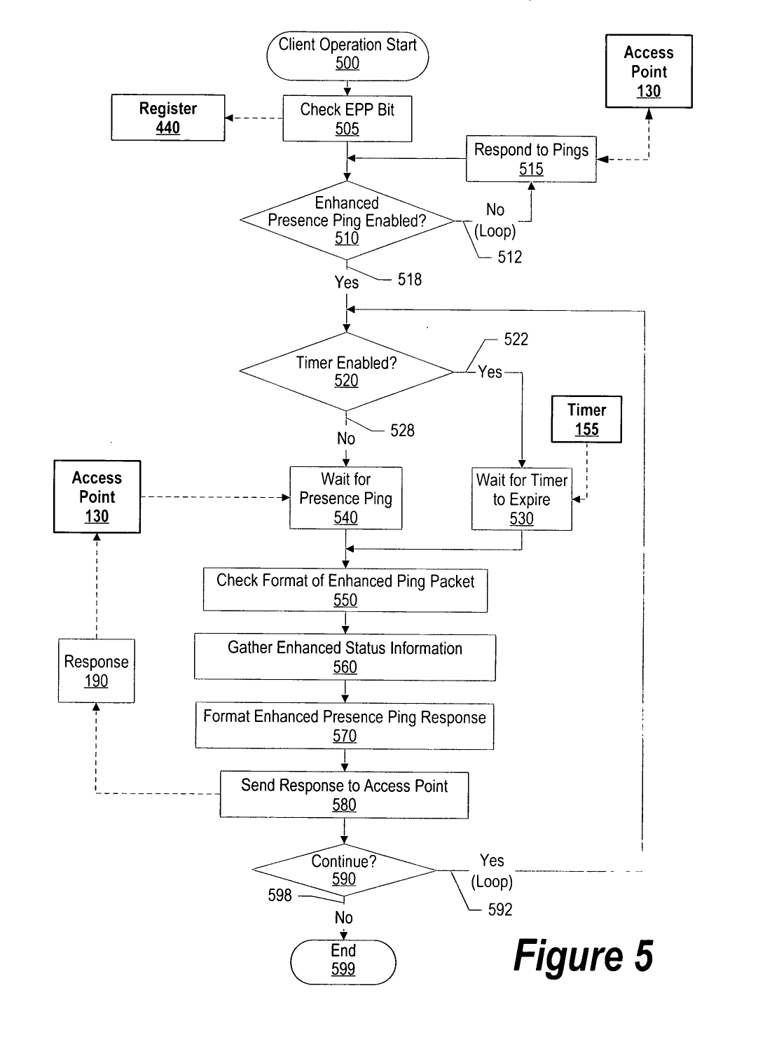

Processing sends a ping request to client 150 at step 360, and receives a ping response at step 370. If client 150's enhanced presence ping bit is enabled, client 150 includes enhanced status information in its ping response (see FIG. 5 and corresponding text for further details regarding client response). A determination is made as to whether to continue processing (decision 380). If processing should continue, decision 380 branches to “Yes” branch 382 which loops back and waits for the access point's timer interval to expire (step 390). The administrator request included a timer interval corresponding to when to retrieve enhanced status information. This looping continues until processing should stop, at which point decision 380 branches to “No” branch 388 whereupon processing ends at 399.

FIG. 4 is a high level flow chart showing steps taken in a client receiving a control packet from an access point, and enabling its enhanced presence ping bit in response to the control packet. Client configuration processing commences at 400, whereupon processing waits for control packets from access point 130 at step 410. The control packets include information as to whether the client should enable enhanced presence ping that, in turn, instructs the client to provide enhanced status information to access point 130. Access point 130 is the same as that shown in FIG. 1.

A determination is made as to whether the client should enable enhanced presence ping (decision 420). If the client should not enable enhanced presence ping, decision 420 branches to “No” branch 422 which loops back to wait for more control packets. This looping continues until the client receives a control packet that instructs it to enable enhanced presence ping, at which point decision 420 branches to “Yes” branch 428 whereupon processing sets an enhanced presence ping bit in register 440 at step 430.

A determination is made as to whether the client should wait for access point ping requests or whether the client should set a timer and provide enhanced status information to access point 130 each time the timer expires (decision 450). If the client should enable a timer, decision 450 branches to “Timer” branch 452 whereupon processing enables timer 155 at step 460. Timer 155 is the same as that shown in FIG. 1. On the other hand, if processing should wait for access point ping requests before sending enhanced status information, decision 450 branches to “Ping” branch 458 bypassing timer setting steps.

A determination is made as to whether to continue client processing (decision 470). If client processing should continue, decision 470 branches to “Yes” branch 472 which loops back to process more control packets. This looping continues until client processing should stop, at which point decision 470 branches to “No” branch 478 whereupon processing ends at 480.

FIG. 5 is a flowchart showing steps taken in a client collecting enhanced status information and sending the enhanced status information to an access point. Client operation processing commences at 500, whereupon processing checks an enhanced presence ping bit located in register 440 at step 505. The enhanced presence ping bit may have been previously enabled in response to an access point control packet request (see FIG. 4 and corresponding text for further details regarding access point control packet requests). Register 440 is the same as that shown in FIG. 4.

A determination is made as to whether the enhanced presence ping bit is enabled (decision 510). If the enhanced presence ping bit is not enabled, decision 510 branches to “No” branch 512 which loops back to respond to access point 130's pings in a typical manner (step 515). Access point 130 is the same as that shown in FIG. 1. This looping continues until the enhanced presence ping bit is enabled, at which point decision 510 branches to “Yes” branch 518.

A determination is made as to whether a timer, such as timer 155, is enabled (decision 520). If timer 155 is enabled, decision 520 branches to “Yes” branch 522 whereupon processing waits for timer 155 to expire (step 530). On the other hand, if timer 155 is not enabled, decision 520 branches to “No” branch 528 whereupon processing waits for a ping request from access point 130 at step 540.

When the client is finished waiting for a ping request, or timer 155 has expired, the client checks the format of an enhanced presence ping control packet to identify which type of status information to collect Processing collects enhanced status information based upon the enhanced presence ping control packet at step 560. Processing formats a response that includes the enhanced status information at step 570, and sends response 190 to access point 130 at step 580. Response 190 is the same as that shown in FIG. 1.

A determination is made as to whether to continue processing (decision 590). If processing should continue, decision 590 branches to “Yes” branch 592 which loops back to collect more enhanced status information. This looping continues until client processing should stop, at which point decision 590 branches to “No” branch 598 whereupon processing ends at 599.

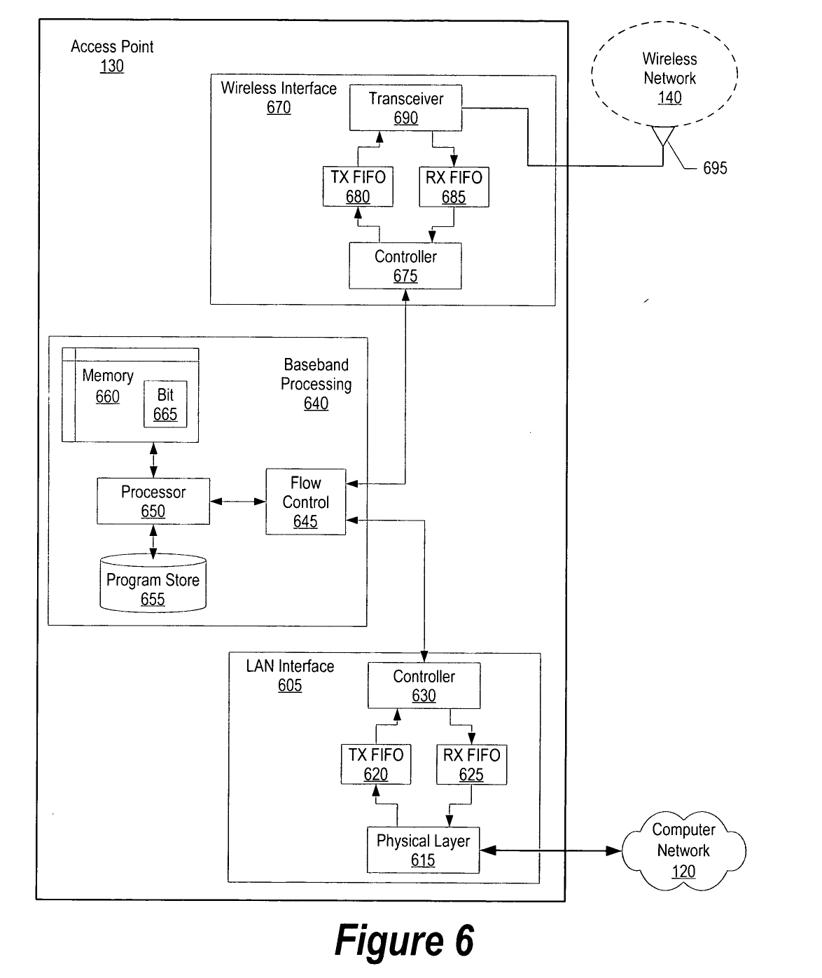

FIG. 6 is a block diagram of an access point that is capable of adapting to the present invention. Access point 130 is the same as that shown in FIG. 1 and includes three modules which are LAN interface 605, base band processing 640, and wireless interface 670. LAN interface 605 includes physical layer 615 that provides an interface, such as Ethernet, to computer network 120. TX FIFO 620 and RX FIFO 625 couples physical layer 615 to controller 630 and provides buffering for transmit and receive data packets.

Controller 630 couples to flow control 645 that is included in base band processing 640 through a standard bus, such as a PCI or ISA bus. Flow control 645 couples to processor 650 that manages base band operations. Processor 650 couples to program store 655 to retrieve program information. Program store 655 is a non-volatile storage device, such as non-volatile memory. Processor 650 is also coupled to memory 660 that is a volatile storage device, such as volatile memory. Memory 660 includes bit 665 which is set when access point 130 is in enhanced presence ping mode.

Flow control 645 interfaces with controller 675 through a standard bus, such as a PCI or ISA bus. TX FIFO 680 and RX FIFO 685 couple controller 675 to transceiver 690 and are used to buffer transmission and reception of data packets that are sent to and received from a client over wireless network 140. Transceiver 690 is coupled to antenna 695 that transmits and receives data packets over wireless network 140.

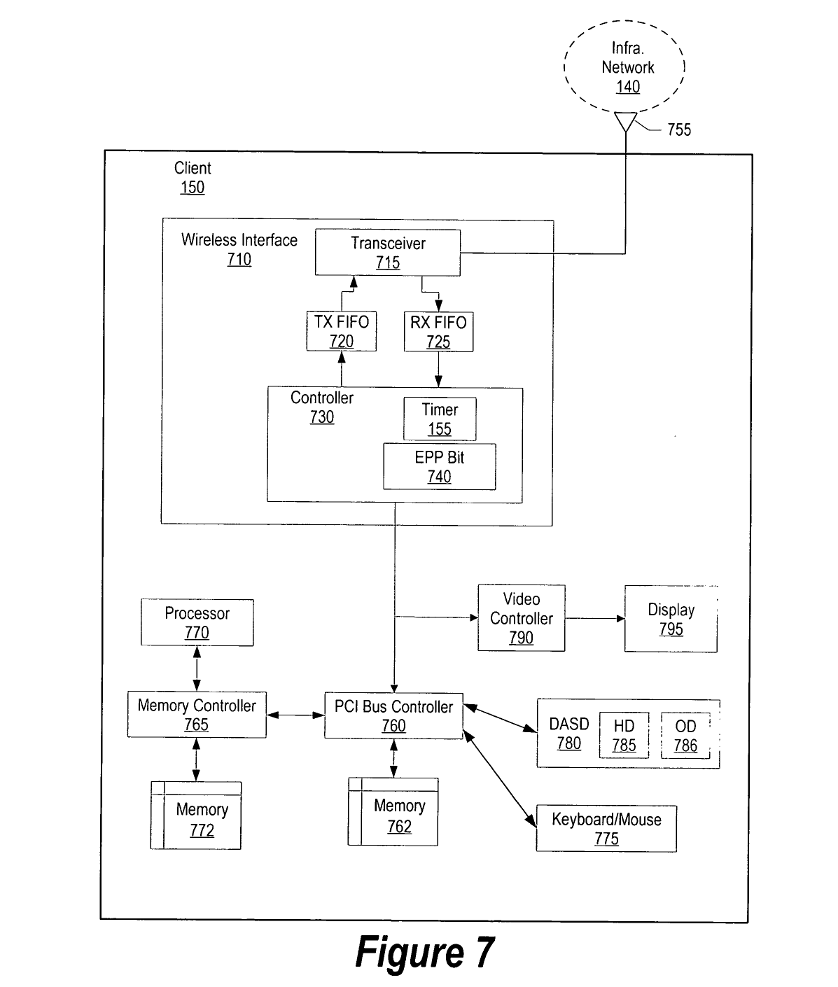

FIG. 7 is a block diagram of an information handling system, such as a client device, capable of implementing the present invention. FIG. 7 illustrates client 150 which is a simplified example of a client capable of performing the computing operations described herein. Client 150 includes wireless interface 710 that includes transceiver 715. Transceiver 715 is an RF (radio frequency) transmitter that uses antenna 755 to communicate with other devices on infrastructure network 140. Client 150 and infrastructure network 140 are the same as that shown in FIG. 1.

TX FIFO 720 and RX FIFO 725 couple controller 730 to transceiver 715 and are used to buffer transmission and reception of data packets that are sent to and received from network devices. Controller 730 includes timer 155 and enhanced presence ping bit 740. Client 150 checks enhanced presence ping bit 740 to determine whether to be in enhanced presence ping mode. Timer 155, if enabled is used to identify times at which to send enhanced status information to an access point.

PCI bus controller 760 operationally couples a variety of modules within client 150. A standard processing subsection is coupled to PCI bus controller 760 and consists of microprocessor 770, memory controller 765, and memory 772. PCI bus controller 760 is also coupled to keyboard/mouse 775 in which a user uses to input information, such as a network name. PCI bus controller 760 is also coupled to DASD 780 that includes hard drive 785 and optical device 786. Client 150 also includes video controller 790 which displays data on display 795 for a user to view.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer implemented method comprising:
retrieving an enhanced presence ping bit;
identifying that the enhanced presence ping bit is enabled, wherein the enablement of the enhanced presence ping bit corresponds to an enhanced presence ping mode;
collecting enhanced status information based upon the identification; and
sending the enhanced status information to an access point over a wireless network.

2. The method of claim 1 further comprising:
determining that a timer is enabled, the timer corresponding to a time at which to send the enhanced status information;
detecting that the enabled timer has expired; and
performing the collecting and the sending in response to the detecting.

3. The method of claim 1 further comprising:
receiving a ping request from the access point; and
performing the collecting and the sending in response to receiving the ping request.

4. The method of claim 1 wherein the enhanced status information is selected from the group consisting of a total packet number, a signal strength, and a system power state.

5. The method of claim 1 further comprising:
receiving an enhanced presence ping control packet from the access point; and
enabling the enhanced presence ping bit in response to receiving the enhanced presence ping control packet.

6. The method of claim 5 wherein the access point is adapted to send the enhanced presence ping control packet in response to receiving an administrator request from an administrator, and wherein the access point is also adapted to provide the collected enhanced status information to the administrator.

7. The method of claim 1 wherein the wireless network functions as a shared transmission medium.

8. An information handling system comprising:
one or more processors;
a memory accessible by the processors;
one or more nonvolatile storage devices accessible by the processors;
one or more registers;
one or more timers; and
a enhanced presence ping tool for providing enhanced status information, the enhanced presence ping tool comprising software code effective to:
retrieve an enhanced presence ping bit from one of the registers;
identify that the enhanced presence ping bit is enabled, wherein the enablement of the enhanced presence ping bit corresponds to an enhanced presence ping mode;
collect enhanced status information from one of the nonvolatile storage devices based upon the identification; and
send the enhanced status information to an access point over a wireless network.

9. The information handling system of claim 8 wherein the software code is further effective to:
determine that one of the timers is enabled, the timer corresponding to a time at which to send the enhanced status information;
detect that the enabled timer has expired; and
perform the collecting and the sending in response to the detecting.

10. The information handling system of claim 8 wherein the software code is further effective to:
receive a ping request from the access point; and
perform the collecting and the sending in response to receiving the ping request.

11. The information handling system of claim 8 wherein the enhanced status information is selected from the group consisting of a total packet number, a signal strength, and a system power state.

12. The information handling system of claim 8 wherein the software code is further effective to:
receive an enhanced presence ping control packet from the access point; and
enable the enhanced presence ping bit in response to receiving the enhanced presence ping control packet.

13. The information handling system of claim 12 wherein the access point is adapted to send the enhanced presence ping control packet in response to receiving an administrator request from an administrator, and wherein the access point is also adapted to provide the collected enhanced status information to the administrator.

14. A program product comprising:
computer operable medium having computer program code, the computer program code being effective to:
retrieve an enhanced presence ping bit;
identify that the enhanced presence ping bit is enabled, wherein the enablement of the enhanced presence ping bit corresponds to an enhanced presence ping mode;
collect enhanced status information based upon the identifying; and
send the enhanced status information to an access point over a wireless network.

15. The program product of claim 14 wherein the software code is further effective to:
determine that a timer is enabled, the timer corresponding to a time at which to send the enhanced status information;
detect that the enabled timer has expired; and
perform the collecting and the sending in response to the detecting.

16. The program product of claim 14 wherein the software code is further effective to:
receive a ping request from the access point; and
perform the collecting and the sending in response to receiving the ping request.

17. The program product of claim 14 wherein the enhanced status information is selected from the group consisting of a total packet number, a signal strength, and a system power state.

18. The program product of claim 14 wherein the software code is further effective to:
receive an enhanced presence ping control packet from the access point; and
enable the enhanced presence ping bit in response to receiving the enhanced presence ping control packet.

19. The program product of claim 18 wherein the access point is adapted to send the enhanced presence ping control packet in response to receiving an administrator request from an administrator, and wherein the access point is also adapted to provide the collected enhanced status information to the administrator.

20. The program product of claim 14 wherein the wireless network functions as a shared transmission medium.
